(19) United States
(12) Patent Application Publication
(10) Pub. No.: US 2008/0195273 A1
(43) Pub. Date: Aug. 14, 2008

(54) Vehicle Control Apparatus and Vehicle Control Method

(75) Inventors: Akira Matsuura, Hyogo (JP); Minoru Yoshimura, Hyogo (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 11/665,074

(22) PCT Filed: Nov. 2, 2005
(86) PCT No.: PCT/JP2005/020222

§ 371 Date: Apr. 11, 2007

(30) Foreign Application Priority Data
Nov. 2, 2004 (JP) 2004-319490

(51) Int. Cl. G01M 17/00

(52) U.S. Cl. 701/34

(57) ABSTRACT

A state judgment unit (21) of an on-vehicle terminal (20) judges whether the vehicle is in operation by using outputs of the operation state of a mobile terminal (10), a key insert switch (32), an ignition switch (33), and a courtesy switch (34). A theft detection unit (22) includes a diagnosis processing unit (22a) and a monitoring processing unit (22b). When the vehicle is in operation, the diagnosis processing unit (22a) executes diagnosis of a human body sensor (41), a vibration sensor (42), and a microphone (43). When the vehicle is not in operation state, the monitoring processing unit (22b) monitors presence/absence of theft action by using the outputs of the human body sensor (41), the vibration sensor (42), and the microphone (43).

### TECHNICAL FIELD

The present invention relates to a vehicle control apparatus that performs monitoring control for a vehicle in a non-driving state and a vehicle control method. Particularly, the present invention relates to a vehicle control apparatus that can automatically diagnoses a sensor that is used for monitoring control and a vehicle control method.

### BACKGROUND ART

Recently, antitheft devices for vehicle that monitors a vehicle in a non-driving state, such as a parked car, to detect intrusion into the vehicle, theft of property from the inside of the vehicle, and theft of the vehicle itself and to give the alarm, have been proposed. Such antitheft devices for vehicle use various sensors, for example, a sensor that detects opening or closing of a door, a trunk, or a hood, a human-body detecting sensor that detects a human body by using ultrasonic wave or microwave, a vibration sensor that detects vibration of the vehicle, and an impact-sound sensor that detects an impact sound arising from an impact applied to the vehicle body or glass.

If a malfunction occurs in such sensors, a trouble occurs, for example, detection of theft event is omitted, or an alarm is given by mistake due to erroneous detection. Therefore, fault diagnosis of a sensor is significant.

By general fault diagnosis, a fault is diagnosed by regularly acquiring an output state of a sensor during operation of the device, and determining disconnection fault if there is no change in the sensor's output for a certain time period. However, antitheft devices for vehicle operate when the vehicle is in a non-driving state (where, for example, the ignition is off, or the engine is stationary) and there is no person inside the vehicle compartment, while the sensors provide no output, so that general fault diagnosis cannot be carried out.

Moreover, in connection with a remote control device that assumed to operate the vehicle from outside the vehicle, for example, a remote starting device that remotely stars the engine, or so-called keyless entry system, which remotely opens and closes, or locks and unlocks doors, the device operate when the vehicle is in a non-deriving state and there is no person inside the vehicle compartment, so that a similar trouble occurs if the device is equipped with a sensor.

Therefore, according to fault diagnosis performed by a vehicle antitheft device as disclosed in Patent Document 1, Patent Document 2, Patent Document 3 and Patent Document 4, a user switches operating condition of a sensor to a fault diagnosis mode by controlling switch, and then performs fault diagnosis.

Patent Document 5 disclose a technology by which output from a switch that detects opening or closing of door, trunk or hood is acquired under a state where the ignition key is off and theft monitoring is not performed, a switch that is in the open state is diagnosed as having a fault, and then output from the diagnosed faulty switch is ignored when performing theft monitoring.

Patent Document 1: Japanese Patent Application Laid-open No. H10-129420

Patent Document 2: Japanese Patent Application Laid-open No. 2000-85532

Patent Document 3: Japanese Patent Application Laid-open No. 2002-331883

Patent Document 4: Japanese Patent Application Laid-open No. 2000-104173

Patent Document 5: U.S. Pat. No. 4,887,064

### DISCLOSURE OF INVENTION

### Problem to be Solved by the Invention

However, according to the method by which fault diagnosis is performed by user's operation, there is a problem that the user is required an effort to determine the timing for fault diagnosis and to switch to the fault diagnosis mode. Accordingly, there is a possibility that appropriate fault diagnosis is not performed, for example, the user does not perform fault diagnosis for a long time.

According to the method by which theft monitoring is performed by ignoring the switch in the open state as described in Patent Document 5, fault diagnosis is unsatisfactory because the method cannot distinguish between the case where the switch is in the open state due to fault and the case where the use actually opens a door.

In other words, according to the conventional technologies, there is a problem that fault diagnosis cannot be automatically and reliably performed for a sensor that is used for monitoring a vehicle in a non-driving state. Therefore, production of a vehicle control apparatus that can automatically diagnose a sensor used for monitoring control and establishment of a vehicle control method is a significant challenge.

The present invention has been made to clear problems of the conventional technologies, and to solve challenges, and an object of the present invention is to provide a vehicle control apparatus that can automatically diagnose a sensor used for monitoring control and a vehicle control method.

### Means for Solving Problem

To solve the above problems and to achieve the object, a vehicle control apparatus according to the invention of claim 1 performs a monitoring control of a vehicle in a non-driving state based on a sensor that collects information for the monitoring control. The vehicle control apparatus includes a driving-state determining unit that determines a driving state of the vehicle and a fault diagnosis unit that performs a fault diagnosis of the sensor upon the driving-state determining unit determining that the vehicle is in a driving state.

According to the invention of claim 1, the vehicle control apparatus determines a state of a vehicle, as a result, if the vehicle is being driven, the vehicle control apparatus performs a fault diagnosis of a sensor to be used for monitoring control performed in a non-driving state.

Furthermore, in the vehicle control apparatus according to the invention of claim 2, if the sensor is normal, an output from the sensor is changed while the vehicle is in the driving state.

According to the invention of claim 2, the vehicle control apparatus performs the fault diagnosis of the sensor, in which if the sensor works normally, change in output occurs while the vehicle is being driven.

Moreover, in the vehicle control apparatus according to the invention of claim 3, the sensor is a human detecting sensor that detects a human body with at least one of ultrasonic wave and radio wave, and the monitoring control is to monitor an intrusion of a person into the vehicle based on an output from the human detecting sensor.

According to the invention of claim 3, the vehicle control apparatus determines the state of the vehicle, as a result, if the vehicle is being driven, the vehicle control apparatus performs the fault diagnosis of a human detecting sensor that detects presence of a human-body with ultrasonic wave and/or radio wave.

Furthermore, in the vehicle control apparatus according to the invention of claim 4, the sensor is a vibration detecting sensor that detects a vibration of the vehicle, and the monitoring control is to monitor a vehicle theft based on an output from the vibration detecting sensor.

According to the invention of claim 4, the vehicle control apparatus determines the state of the vehicle, as a result, if the vehicle is being driven, the vehicle control apparatus performs the fault diagnosis of a vibration detecting sensor that detects vibration of the vehicle.

Moreover, in the vehicle control apparatus according to the invention of claim 5, the sensor is an impact-sound sensor that detects an impact sound, and the monitoring control is to monitor an occurrence of an impact on at least one of a body and a glass of the vehicle.

According to the invention of claim 5, the vehicle control apparatus determines a state of a vehicle, as a result, if the vehicle is being driven, the vehicle control apparatus performs the fault diagnosis of an impact-sound sensor that detects an impact sound.

Furthermore, in the vehicle control apparatus according to the invention of claim 6, when the vehicle is in the driving state, and when the sensor outputs what is supposed to be output along with a driving operation, the fault diagnosis unit diagnoses that the sensor is normal.

According to the invention of claim 6, when the vehicle is being driven, and a sensor gives output that is supposed to occur along with driving operation, the vehicle control apparatus diagnoses that the sensor is normal.

Moreover, in the vehicle control apparatus according to the invention of claim 7, when the vehicle is in the driving state, and when the sensor dose not output what is supposed to be output along with a driving operation, the fault diagnosis unit diagnoses that the sensor has a fault.

According to the invention of claim 7, when the vehicle is being driven, and a sensor dose not give output that is supposed to occur along with driving operation, the vehicle control apparatus diagnoses that the sensor is faulty.

Furthermore, in the vehicle control apparatus according to the invention of claim 8, when the vehicle is in the driving state, and if the sensor dose not output what is supposed to be output along with the driving operation for a predetermined time, the fault diagnosis unit diagnoses that the sensor has a fault.

According to the invention of claim 8, when the vehicle is being driven, and if a state where the sensor dose not give output that is supposed to occur along with driving operation lasts for a predetermined time period, the vehicle control apparatus diagnoses that the sensor is faulty.

Moreover, in the vehicle control apparatus according to the invention of claim 9, the fault diagnosis unit performs the fault diagnosis during one trip from a beginning of driving to an end of driving, and if the fault diagnosis unit diagnoses that the sensor is faulty across a plurality of trips, the fault diagnosis unit diagnoses that the sensor has a fault.

According to the invention of claim 9, the vehicle control apparatus performs the fault diagnosis of the sensor during a trip from the beginning of the driving until the end of the driving, and then if the sensor is diagnosed as having a fault in a plurality of trips, the diagnosis concludes that the sensor has a fault.

Furthermore, in the vehicle control apparatus according to the invention of claim 10, the fault diagnosis unit makes a notification of a result of the fault diagnosis after a vehicle driving is ended.

According to the invention of claim 10, when the vehicle is being driven, the vehicle control apparatus performs the fault diagnosis of the sensor to be used for monitoring control performed in a non-driving state, and gives notice of a diagnosis result after the driving of the vehicle is finished.

Moreover, in the vehicle control apparatus according to the invention of claim 11, when an ignition switch is turned ON, the driving-state determining unit determines that the vehicle is in the driving state.

According to the invention of claim 11, the vehicle control apparatus determines that the vehicle is being driven when the ignition switch is ON, and performs the fault diagnosis of the sensor to be used for the monitoring control performed in a non-driving state.

Furthermore, in the vehicle control apparatus according to the invention of claim 12, when an engine is in operation, the driving-state determining unit determines that the vehicle is in the driving state.

According to the invention of claim 12, the vehicle control apparatus determines that the vehicle is being driven when the engine is in operation, and performs the fault diagnosis of the sensor to be used for the monitoring control performed in a non-driving state.

Moreover, in the vehicle control apparatus according to the invention of claim 13, when the vehicle is running at a predetermined speed or faster, the driving-state determining unit determines that the vehicle is in the driving state.

According to the invention of claim 13, the vehicle control apparatus determines that the vehicle is being driven when the vehicle is running at a predetermined speed or higher, and performs the fault diagnosis of the sensor to be used for the monitoring control performed in a non-driving state.

Furthermore, the vehicle control apparatus according to the invention of claim 14 further includes a power managing unit that manages a power supply to the sensor. The power managing unit selectively performs the power supply to the sensor when the monitoring control is performed using the sensor and when the fault diagnosis of the sensor is performed.

According to the invention of claim 14, the vehicle control apparatus determines the driving state of the vehicle, as a result, if the vehicle is being driven, the vehicle control apparatus activates the sensor to be used for the monitoring control performed in a non-driving state by supplying the power to the sensor, and then performs the fault diagnosis.

Moreover, a vehicle control method according to the invention on claim 15 is for performing a monitoring control of a vehicle in a non-driving state based on a sensor that collects information for the monitoring control. The vehicle control method includes a step of determining a driving state of the vehicle and a step of performing a fault diagnosis of the sensor when it is determined that the vehicle is in a driving state.

According to the invention of claim 15, the vehicle control method performs the fault diagnosis of the sensor to be used for controlling monitoring the vehicle in a non-driving state while the vehicle is being driven.

### EFFECT OF THE INVENTION

According to the invention of claim 1, the vehicle control apparatus determines a state of a vehicle, as a result, if the vehicle is being driven, the vehicle control apparatus performs a fault diagnosis of a sensor to be used for monitoring control performed in a non-driving state. Accordingly, the vehicle control apparatus that can performs an automatic diagnosis of the sensor to be used for the monitoring control performed in a non-driving state, can be obtained.

Moreover, according to the invention of claim 2, the vehicle control apparatus performs the fault diagnosis of the sensor, in which if the sensor works normally, change in output occurs while the vehicle is being driven. Accordingly, the vehicle control apparatus that can performs the automatic diagnosis of the sensor by using output change during the driving, can be obtained.

Furthermore, according to the invention of claim 3, the vehicle control apparatus determines the state of the vehicle, as a result, if the vehicle is being driven, the vehicle control apparatus performs the fault diagnosis of a human detecting sensor that detects presence of a human body with ultrasonic wave and/or radio wave. Accordingly, the vehicle control apparatus that can performs the automatic diagnosis of the human detecting sensor to be used for the monitoring control performed in a non-driving state, can be obtained.

Moreover, according to the invention of claim 4, the vehicle control apparatus determines the state of the vehicle, as a result, if the vehicle is being driven, the vehicle control apparatus performs the fault diagnosis of a vibration detecting sensor that detects vibration of the vehicle. Accordingly, the vehicle control apparatus that can performs the automatic diagnosis of the vibration detecting sensor to be used for the monitoring control performed in a non-driving state, can be obtained.

Furthermore, according to the invention of claim 5, the vehicle control apparatus determines a state of a vehicle, as a result, if the vehicle is being driven, the vehicle control apparatus performs the fault diagnosis of an impact-sound sensor that detects an impact sound. Accordingly, the vehicle control apparatus that can performs the automatic diagnosis of the impact-sound sensor to be used for the monitoring control performed in a non-driving-state, can be obtained.

Moreover, according to the invention of claim 6, when the vehicle is being driven, and a sensor gives output that is supposed to occur along with driving operation, the vehicle control apparatus diagnoses that the sensor is normal. Accordingly, the vehicle control apparatus that can performs the automatic diagnosis of the sensor to be used for the monitoring control performed in a non-driving state, can be obtained.

Furthermore, according to the invention of claim 7, when the vehicle is being driven, and a sensor dose not give output that is supposed to occur along with driving operation, the vehicle control apparatus diagnoses that the sensor is faulty. Accordingly, the vehicle control apparatus that automatically detects a fault in the sensor to be used for the monitoring control performed in a non-driving state, can be obtained.

Moreover, according to the invention of claim 8, when the vehicle is being driven, and if a state where the sensor does not give output that is supposed to occur along with driving operation lasts for a predetermined time, the vehicle control apparatus diagnoses that the sensor is faulty. Accordingly, the vehicle control apparatus that can detect automatically and accurately a fault in the sensor to be used for the monitoring control performed in a non-driving state, can be obtained.

Furthermore, according to the invention of claim 9, the vehicle control apparatus performs the fault diagnosis of the sensor during a trip from the beginning of the driving until the end of the driving, and then if the sensor is diagnosed as having a fault in a plurality of trips, the diagnosis concludes that the sensor has a fault. Accordingly, the vehicle control apparatus that can accurately detect a-fault in the sensor to be used for the monitoring control performed in a non-driving state, can be obtained.

Moreover, according to the invention of claim 10, when the vehicle is being driven, the vehicle control apparatus performs the fault diagnosis of the sensor to be used for monitoring control performed in a non-driving state, and gives notice of a diagnosis result after the driving of the vehicle is finished. Accordingly, the vehicle control apparatus that performs the automatic diagnosis of the sensor to be used for the monitoring control performed in a non-driving state, and gives notice of the diagnosis result without disturbing the driving operation, can be obtained.

Furthermore, according to the invention of claim 11, the vehicle control apparatus determines that the vehicle is being driven when the ignition switch is ON, and performs the fault diagnosis of the sensor to be used for the monitoring control performed in a non-driving state. Accordingly, the vehicle control apparatus that automatically performs the diagnosis of the sensor to be used for the monitoring control performed in a non-driving state while the ignition switch is ON, can be obtained.

Moreover, according to the invention of claim 12, the vehicle control apparatus determines that the vehicle is being driven when the engine is in operation, and performs the fault diagnosis of the sensor to be used for the monitoring control performed in a non-driving state. Accordingly, the vehicle control apparatus that automatically performs the diagnosis of the sensor to be used for the monitoring control performed in a non-driving state while the engine is in operation, can be obtained.

Furthermore, according to the invention of claim 13, the vehicle control apparatus determines that the vehicle is being driven when the vehicle is running at a predetermined speed or higher, and performs the fault diagnosis of the sensor to be used for the monitoring control performed in a non-driving state. Accordingly, the vehicle control apparatus that automatically performs the diagnosis of the sensor to be used for the monitoring control performed in a non-driving state while the vehicle is running, can be obtained.

Moreover, according to the invention of claim 14, the vehicle control apparatus determines the driving state of the vehicle, as a result, if the vehicle is being driven, the vehicle control apparatus activates the sensor to be used for the monitoring control performed in a non-driving state by supplying the power to the sensor, and then performs the fault diagnosis. Accordingly, the vehicle control apparatus that can automatically diagnose the sensor to be used for the monitoring control performed in a non-driving state while suppressing power consumption, can be obtained.

Furthermore, according to the invention of claim 15, the vehicle control method performs the fault diagnosis of the sensor to be used for controlling monitoring the vehicle in a non-driving state while the vehicle is being driven. Accordingly, the vehicle control method for performing the automatic diagnosis of the sensor to be used for the monitoring control performed in a non-driving state can be obtained.

### BRIEF DESCRIPTION OF DRAWINGS

FIG. 1 is a block diagram illustrating a relevant configuration of a vehicle antitheft system according to a first embodiment of the present invention;

FIG. 2 is a schematic diagram for explaining a switching of operation between diagnosis processing and theft monitoring processing;

FIG. 3 is a flowchart of a processing operation of an in-vehicle terminal shown in FIG. 1;

FIG. 4 is a flowchart for explaining a specific example of the diagnosis processing shown in FIG. 3;

FIG. 5 is a flowchart for explaining a specific example of a diagnosis-result notifying processing shown in FIG. 3;

FIG. 6 is a flowchart for explaining a specific example of the theft monitoring processing shown in FIG. 3;

FIG. 7 is a block diagram illustrating a relevant configuration of a vehicle antitheft system according to a second embodiment of the present invention;

FIG. 8 is a flowchart for explaining a specific example of a diagnosis processing according to the second embodiment of the present invention;

FIG. 9 is a flowchart for explaining a specific example of a diagnosis-result notifying processing according to the second embodiment of the present invention;

FIG. 10 is a block diagram illustrating a relevant configuration of a vehicle antitheft system according to a third embodiment of the present invention;

FIG. 11 is a flowchart of a processing operation of an in-vehicle terminal shown in FIG. 10;

FIG. 12 is a flowchart for explaining a specific example of a diagnosis processing shown in FIG. 11; and

FIG. 13 is a flowchart for explaining a specific example of a diagnosis-result notifying processing shown in FIG. 12.

### EXPLANATIONS OF LETTERS OR NUMERALS

10 Mobile terminal
11 Lock button
12 Unlock button
13, 31 Antenna
20 In-vehicle terminal
21 State determining unit
22 Theft detecting unit
22a Diagnosis processing unit
22b Monitoring processing unit
22c Comparison processing unit
23 Power managing unit
32 Key insertion switch
33 Ignition switch
34 Courtesy switch
35 Navigation device
36 Vehicle speed sensor
37 Starter switch
41 Human sensor
42 Vibration sensor
43 Microphone
50 Lock motor
51 Display
52 Speaker
61 Horn
62 Hazard

### BEST MODE(S) FOR CARRYING OUT THE INVENTION

Exemplary embodiments of a vehicle control apparatus and a vehicle control method according to the present invention are explained in detail below with reference to the accompany drawings.

### First Embodiment

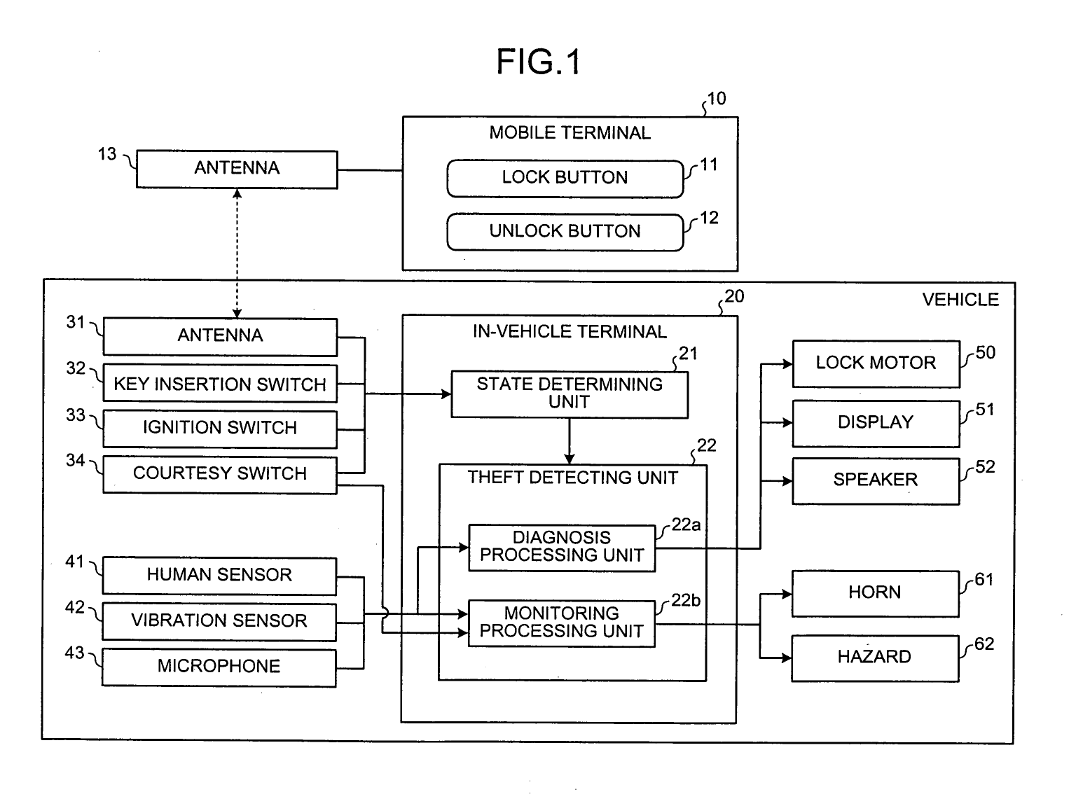

FIG. 1 is a block diagram illustrating a relevant configuration of a vehicle antitheft system according to a first embodiment of the present invention. As shown in the figure, the vehicle antitheft system includes a mobile terminal 10, which is a transmitter held by a user, such as a driver, and an in-vehicle terminal 20, which is a control unit to be installed on a vehicle.

The mobile terminal 10 includes a lock button 11 and an unlock button 12, and is connected to an antenna 13. The lock button 11 is a button that accepts input of a locking instruction to doors of the vehicle equipped with the in-vehicle terminal 20 and a setting instruction of a theft monitoring mode. When the lock button 11 is pressed down, the mobile terminal 10 transmits a locking instruction code to the in-vehicle terminal 20 via the antenna 13.

The unlock button 12 is a button that accepts input of an unlocking instruction to the doors of the vehicle equipped with the in-vehicle terminal 20 and a resetting instruction of the theft monitoring mode. When the unlock button 12 is pressed down, the mobile terminal 10 transmits an unlocking instruction code to the in-vehicle terminal 20 via the antenna 13.

Thus, a user (for example, a driver) can perform locking or unlocking of the doors of the vehicle and setting or resetting of the theft monitoring mode by pressing the lock button 11 or the unlock button 12. In other words, the mobile terminal 10 works as a remote control terminal (remote key) for a wireless door-lock device and an antitheft device of the vehicle equipped with the in-vehicle terminal 20.

The in-vehicle terminal 20 is connected to an antenna 31, a key insertion switch 32, an ignition switch 33, a courtesy switch 34, a human sensor 41, a vibration sensor 42, a-microphone 43, a lock motor 50, a display 51, a speaker 52, a horn 61, and a Hazard 62.

The key insertion switch 32 is a switch that detects an insertion of an ignition key into the ignition key cylinder. If the ignition key is in the ignition key cylinder, the key insertion switch 32 is ON, and if the ignition key is not in the ignition key cylinder, the key insertion switch 32 is OFF. The ignition switch 33 is a switch that switches ON and OFF by operating the ignition key to control various vehicle control devices, such as an engine controller.

The courtesy switch 34 interlocks with an opening-closing unit (door, trunk, hood, and the like) of the vehicle equipped with the in-vehicle terminal 20. If the opening-closing unit is open, the courtesy switch 34 is ON, and vice versa. The courtesy switch 34 is provided at each of a plurality of opening-closing units of the vehicle.

The human sensor 41 is a sensor that detects a human body by using ultrasonic wave or microwave, and to be used for detecting a suspicious person inside the vehicle. The vibration sensor 42 is a sensor that detects vibration of the vehicle body and windows. The microphone 43 works as an impact-sound sensor to detect an impact sound that is emitted if any impact is applied to the vehicle body or glass.

The lock motor 50 is a motor that operates locking and unlocking of door locks of the vehicle. The display 51 is a notifying unit that provides notification to the user inside the vehicle, for example, the driver, via screen display. The speaker 52 is a notifying unit that provides notification to the user inside the vehicle with sound. It is preferred that the display 51 and the speaker 52 are shared with a navigation system or an in-vehicle audio device.

The horn 61 is an alarm that gives notice of presence of the vehicle to the surroundings of the vehicle. For the antitheft purpose, the horn 61 can be used as an alarm to give notice of the occurrence of a theft event and to repulse a suspicious person. The Hazard 62 can be used for transmitting information to the user, for example, completion of door lock, depending on the number of times of simultaneous flashing of blinkers of the vehicle, and used as an alarm when a theft event occurs.

The in-vehicle terminal 20 is permanently activated as battery voltage is supplied regardless of the state of ON or OFF of the ignition switch 33, and includes therein a state determining unit 21 and a theft detecting unit 22. The state determining unit 21 determines the state of the vehicle by using an instruction code received via the antenna 31 and output from the key insertion switch 32, the ignition switch 33, and the courtesy switches 34.

The state determining unit 21 also performs unlocking or locking of the doors by controlling the lock motor 50 when receiving the unlocking instruction code or the locking instruction code via the antenna 31.

The theft detecting unit 22 further includes a diagnosis processing unit 22a and a monitoring processing unit 22b, and activates the diagnosis processing unit 22a or the monitoring processing unit 22b in accordance with the state of the vehicle determined by the state determining unit 21.

If the state determining unit 21 determines that the vehicle is being driven, the diagnosis processing unit 22a performs fault diagnoses of sensors each of which is supposed to generate change in output if it works normally, namely, the human sensor 41, the vibration sensor 42, and the microphone 43. By contrast, if the state determining unit 21 determines that the vehicle is in a non-driving state (where, for example, the engine is stationary, and the doors are locked, that is, the theft monitoring mode is set), the monitoring processing unit 22b performs processing of monitoring the occurrence of theft event based on output from the courtesy switches 34, the human sensor 41, the vibration sensor 42, and the microphone 43.

In other words, theft monitoring processing performed by the monitoring processing unit 22b is carried out when the vehicle is stationary and the inside of the vehicle is unattended. Thus, if the courtesy switch 34 detects opening of a door, or the human sensor 41 detects a human body inside the vehicle, it can be determined that an intruder is present; if the vibration sensor 42 detects a vibration from the vehicle, it can be determined that there is a possibility of a theft event; and if the microphone 43 detects an impact sound, it can be determined that an impact is applied to the vehicle body or the glass.

If the monitoring processing unit 22b determines that an intruder is present, that there is a possibility of a theft event, or that an impact is applied to the vehicle body or the glass, precisely, if a theft event is detected, the monitoring processing unit 22b gives notice of the event to the surroundings or carries out a repulse of a suspicious person by using the horn 61 and the Hazard 62.

By contrast, diagnosis processing performed by the diagnosis processing unit 22a is carried out when a driver is present inside the vehicle and driving the vehicle, so that if the human sensor 41 works normally, the human sensor 41 detects the driver. Accordingly, if the human sensor 21 detects a human body inside the vehicle in the diagnosis processing, it can be determined that the human sensor 21 is normal; in contrast, if the human sensor 21 does not detect human body inside the vehicle, it can be determined that the human sensor 21 is faulty.

Similarly, because the vehicle body vibrates while the vehicle is being driven, if the vibration sensor 42 detects vibration in the diagnosis processing, it can be determined that the vibration sensor 42 is normal; in contrast, if the vibration sensor 42 does not detect vibration, it can be determined that the vibration sensor 42 is faulty.

Furthermore, because a driving noise is emitted while the vehicle is running, if the microphone 43 detects the driving noise in the diagnosis processing, it can be determined that the microphone 43 is normal; in contrast, if the microphone 43 does not detect the driving noise, it can be determined that the microphone 43 is faulty.

In the theft monitoring processing performed by the microphone 43, to detect an impact sound against the vehicle body or the glass selectively, the impact sound is processed via a filter appropriate to a frequency of the impact sound. However, because the driving noise used for the diagnosis processing has a different frequency from the impact sound, there is a possibility that the driving noise is filtered out with a filter for the theft monitoring processing. In addition, a determination threshold to be used for the diagnosis processing is not necessarily the same value as a determination threshold to be used for the theft monitoring processing.

Therefore, it is desirable that processing to be performed on output from the microphone 43 is switched between during the diagnosis processing and during the theft monitoring processing.

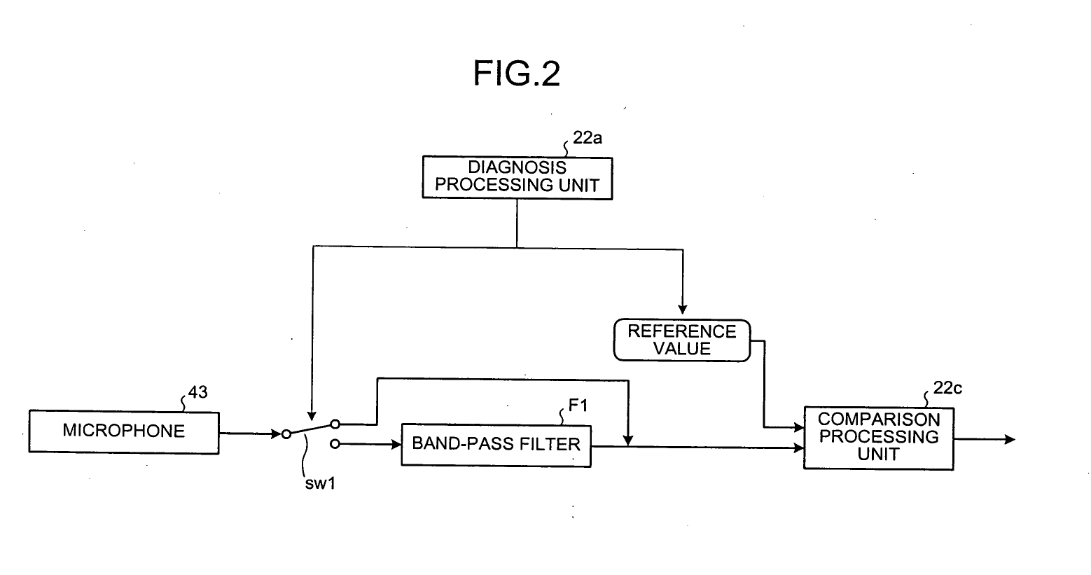

A specific example of switching the processing between the diagnosis processing and the theft monitoring processing is shown in FIG. 2. In the figure, two paths are provided, namely, a theft monitoring path through which output from the microphone 43 is filtered via a band-pass filter F1 and is input into a comparison processing unit 22c, and a diagnosis path through which output from the microphone 43 is directly input into the comparison processing unit 22c. A switch SW1 selects one of the two paths.

The diagnosis processing unit 22a selects the diagnosis path by switching the switch SW1 when executing the diagnosis processing, and directly inputs the output from the microphone 43 into the comparison processing unit 22c. Although the configuration shown here as an example is that the output from the microphone 43 is directly input to the comparison processing unit 22c, it can be configured to be input via an appropriate filter for the diagnosis processing.

The comparison processing unit 22c compares the output from the microphone 43 with a reference value. According to a result of the comparison, if the output from the microphone 43 is larger than the reference value, it is determined during the theft monitoring processing that an impact is applied to the vehicle body or the glass, while it is determined during the diagnosis processing that the microphone is normal.

The diagnosis processing unit 22a then changes the reference value used by the comparison processing unit 22c to a value for the diagnosis processing when performing the diagnosis processing.

Thus, the filtering characteristics and the determination threshold are switched between the diagnosis processing and the theft monitoring processing, so that theft detection accuracy and diagnosis accuracy can be improved.

Switching of operation between the diagnosis processing and the theft monitoring processing is also applicable to the other sensors, such as the human sensor 41 and the vibration sensor 42, in addition to the microphone 43.

The diagnosis processing unit 22a notifies the driver a result of the diagnosis performed by the diagnosis processing unit 22a by using the display 51 and the speaker 52. Although the diagnosis processing itself is performed during the driving, it is desirable that the diagnosis result is notified to the driver after the driving is finished to avoid disturbing driving operation by the driver.

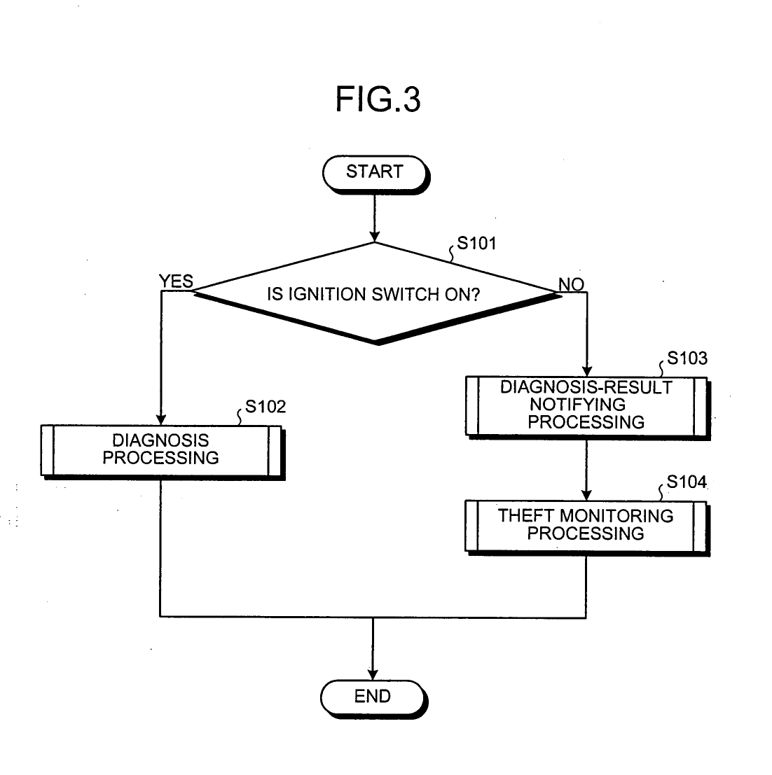

A processing operation of the in-vehicle terminal 20 is explained below with reference to FIG. 3. Steps in a flowchart shown in the figure are repeated while the in-vehicle terminal 20 is in a power-on state.

The state determining unit 21 acquires the state of the ignition switch 33, and determines whether the ignition switch 33 is ON (step S101). As a result, if the ignition switch 33 is ON (Yes at step S101), it is determined that the vehicle is being driven, the diagnosis processing unit 22a performs the diagnosis processing (step S102), and then the processing is terminated.

By contrast, if the ignition switch 33 is OFF (No at step S101), the diagnosis processing unit 22a performs diagnosis-result notifying processing (step S103). The monitoring processing unit 22b then performs the theft monitoring processing (step S104), and the processing is terminated.

In the following, specific processing details of the diagnosis processing (step S102), the diagnosis-result notifying processing (step S103), and the theft monitoring processing (step S104) shown in FIG. 3 are explained.

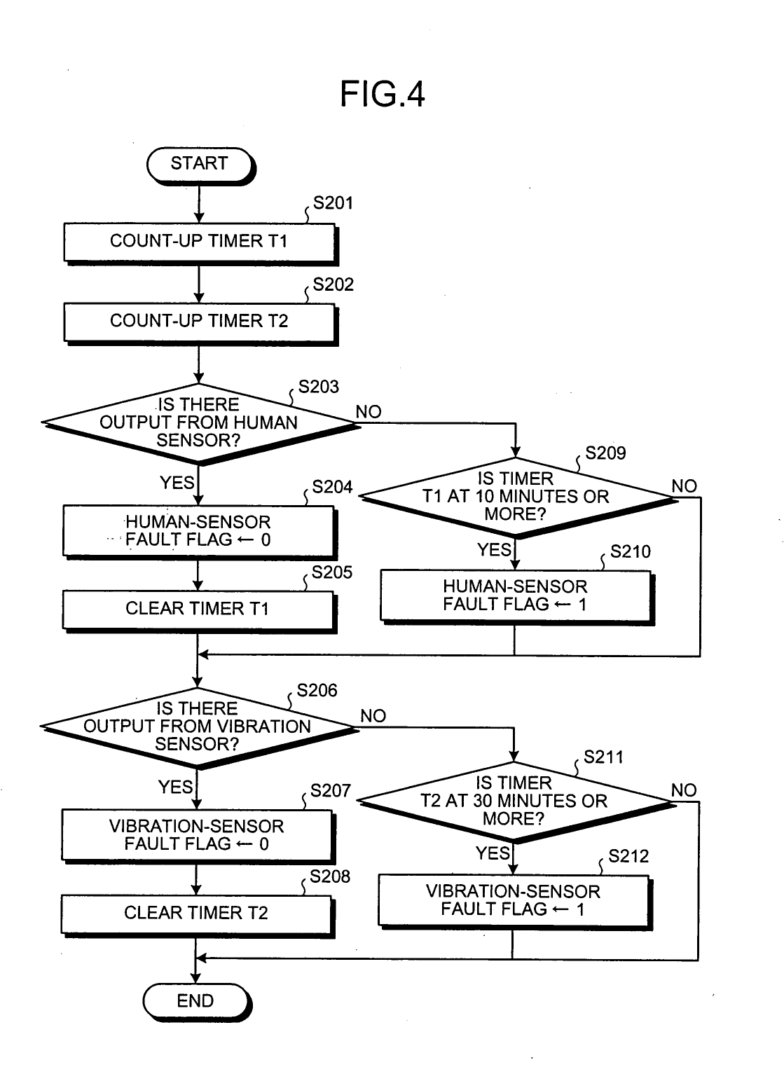

First of all, FIG. 4 is a flowchart for explaining specific processing details of the diagnosis processing (step S102). As shown in the figure, the diagnosis processing unit 22a performs count-up of a timer T1 (step S201) and count-up of a timer T2 (step S202) at first.

Subsequently, it is determined whether there is output from the human sensor 41 (step S203). As a result, if there is output from the human sensor 41 (Yes at step S203), it is determined that the human sensor 41 is normal, so that the value of a human-sensor fault flag is reset to “0” (step S204), and the timer T1 is cleared (step S205).

By contrast, if there is no output from the human sensor 41 (No at step S203), the diagnosis processing unit 22a determines whether the timer T1 is at 10 minutes or more (step S209). If the timer T1 is at 10 minutes or more (Yes at step S209), it is determined that the human sensor 41 is faulty, so that the value of the human-sensor fault flag is set to “1” (step S210).

After the timer T1 is cleared (step S205), or after the human-sensor fault flag is set (step S210), or when the timer T1 is at less than 10 minutes (No at step S209), in the next, the diagnosis processing unit 22a determines whether there is output from the vibration sensor 42 (step S206).

As a result, if there is output from the vibration sensor 42 (Yes at step S206), it is determined that the vibration sensor 42 is normal, so that the value of the vibration-sensor fault flag is reset to “0” (step S207), the timer T2 is cleared (step S208), and then the processing is terminated.

By contrast, if there is no output from the vibration sensor 42 (No at step S206), the diagnosis processing unit 22a determines whether the timer T2 is at 30 minutes or more (step S211). If the timer T2 is at less than 30 minutes (No at step S211), the processing is terminated. By contrast, if the timer T2 is at 30 minutes or more (Yes at step S211), it is determined that the vibration sensor 42 is faulty, so that the value of the vibration-sensor fault flag is set to “1” (step S212), and the processing is terminated.

In this way, according to the diagnosis processing shown in FIG. 4, if the ignition is ON, and the output from the human sensor 41 is not detected for 10 minutes or more, it is determined that the human sensor 41 is faulty; and if the output from the vibration sensor 42 is not detected for 30 minutes or more, it is determined that the vibration sensor 42 is faulty.

Here, the threshold time for the human sensor 41 is set to 10 minutes, while the threshold time for the vibration sensor 42 is set to 30 minutes. Because if the ignition is ON, it is considered that a driver is present inside the vehicle regardless whether the vehicle is being driven or stationary, the human sensor 41 is expected to detect the driver surely, on the other hand, it is conceivable that the vibration sensor 42 does not output while the vehicle is stationary. The values such as 10 minutes and 30 minutes are mere examples; therefore, can be changed to appropriate values.

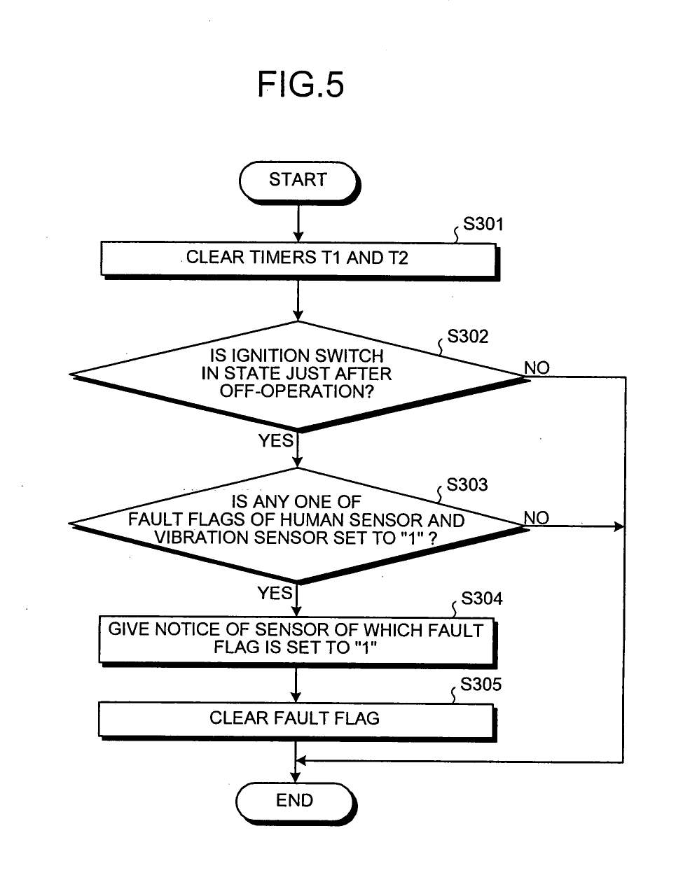

In the next, specific processing details of the diagnosis-result notifying processing (step S103) are explained with reference to a flowchart shown in FIG. 5. In the diagnosis-result notifying processing, the diagnosis processing unit 22a clears the values of the timer T1 and the timer T2 (step S301) at first.

Subsequently, it is determined whether the ignition switch 33 is in a state just after an OFF-operation (operation of switching from ON to OFF) (step S302). If the ignition switch 33 is not in the state just after the OFF-operation (No at step S302), the processing is terminated.

By contrast, if the ignition switch 33 is in the state just after the OFF-operation (Yes at step S302), the diagnosis processing unit 22a determines that the driving is finished, and then determines whether any one of the fault flags of the human sensor 41 and the vibration sensor 42 has the value “1” (step S303).

As a result, if none of the fault flags has the value “1” (No at step S303), the processing is directly terminated. If there is a fault flag at the value “1” (Yes at step S303), the corresponding sensor is noticed (step S304), the fault flag (step S305) is cleared, and the processing is terminated. As the notice of the faulty sensor, notice in letters or sensor-image illustration using the display 51, and notice in synthetic voice using the speaker 52 are conceivable, however, other methods can be used.

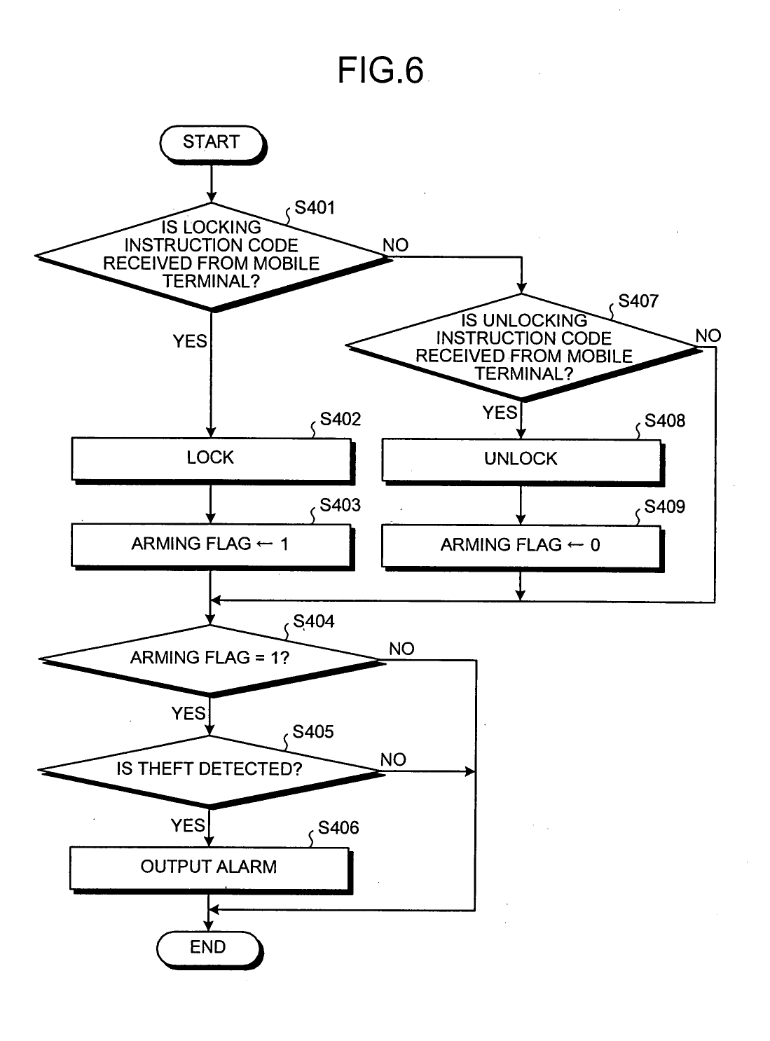

Processing details of the theft monitoring processing (step S103) are explained below with reference to a flowchart shown in FIG. 6. In the theft monitoring processing, the-state determining unit 21 determines at first whether the locking instruction code is received from the mobile terminal 10 (step S401). As a result, if the locking instruction code is received (Yes at step S401), the lock motor 50 is activated to lock the doors (step S402), and an arming flag is set to “1” (step S403). Here, the arming flag is a flag that indicates the theft monitoring mode, where “1” indicates a state that the theft monitoring mode is activated, and “0” indicates a state that the theft monitoring mode is reset. Thus, according to step S403, the theft monitoring mode is set.

By contrast, if the locking instruction code is not received (No at step S401), the state determining unit 21 determines whether the unlocking instruction code is received from the mobile terminal 10 (step S407). As a result, if the unlocking code is received (Yes at step S407), the lock motor 50 is activated to unlock the doors (step S408), and the arming flag is reset to “0” (step S409).

After setting (step S403) or resetting (step S409) of the arming flag is finished, or when the unlocking instruction code is not received from the mobile terminal 10 (No at step S408), the monitoring processing unit 22b determines whether the value of the arming flag is “1” (step S404).

As a result, if the value of the arming flag is “1” (Yes at step S404), the monitoring processing unit 22b performs detection of theft event based on output from the courtesy switch 34, the human sensor 41, the vibration sensor 42, and the microphone 43 (step S405). If a theft event is detected (Yes at step S405), an alarm is output by using the horn 61 and the Hazard 62 (step S406), and then the processing is terminated.

By contrast, if the value of the arming flag is not “1” (i.e., the value is “0”) (No at step S404), or if no theft event is detected (No at step S405), the processing is directly terminated.

As described above, the vehicle antitheft system according to the first embodiment determines the state of the vehicle, and then if the vehicle is being driven (in the state where the ignition switch is ON), the antitheft system performs diagnoses of the sensors for the theft monitoring (the human sensor 41, the vibration sensor 42, and the microphone 43) in each of which an output change is supposed to be observed during the driving if it works normally, so that the antitheft system can performs the fault diagnosis automatically and reliably.

For the purpose of simplification of explanations in the embodiment, the specific processing flows are shown for the diagnoses of the human sensor 41 and the vibration sensor 42, meanwhile a specific example of the diagnosis processing on the microphone 43 has been omitted. However, a diagnosis of the microphone 43 can be performed by applying a similar processing flow. In addition to the human sensor 41, the vibration sensor 42, and the microphone 43 exemplified in the embodiment, any sensor to be used for monitoring in a non-driving state can be diagnosed similarly.

### Second Embodiment

The first embodiment described above explains the antitheft system that determines whether the vehicle is being driven based on whether the ignition switch 33 is ON, performs the diagnosis of each of the sensors, and gives notice of a result of the diagnosis performed during the driving after the driving is finished. A second embodiment explains an antitheft system that determines diagnosis timing of the sensors by using a vehicle speed and a state of a starter switch in addition to the state of the ignition switch 33, and gives notice based on diagnosis results of a plurality of trips (from the driving start to the driving end).

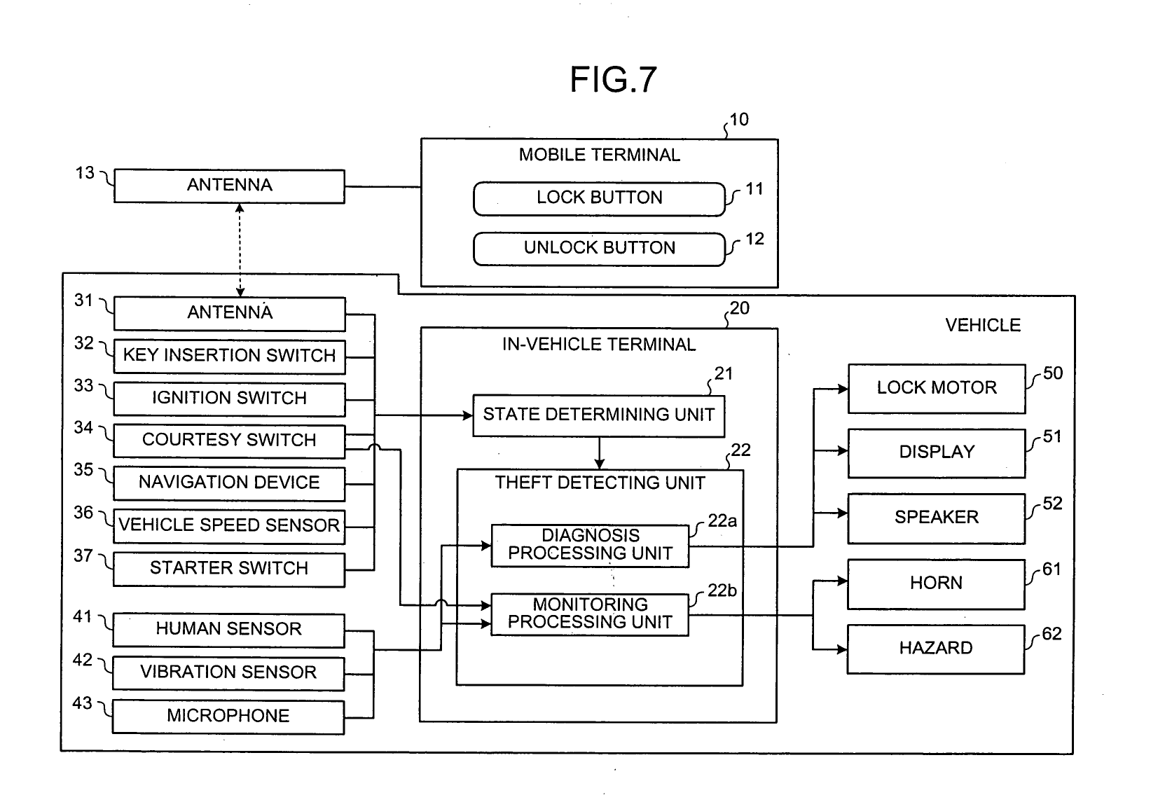

FIG. 7 is a block diagram illustrating a relevant configuration of a vehicle antitheft system according to the second embodiment of the invention. As shown in the figure, the vehicle antitheft system includes the mobile terminal 10, which is a transmitter held by a user, such as a driver, and the in-vehicle terminal 20, which is a control unit to be installed on a vehicle. The in-vehicle terminal 20 is connected to a navigation device 35, a vehicle speed sensor 36, and a starter switch 37, in addition to the antenna 31, the key insertion switch 32, the ignition switch 33, the courtesy switches 34, the human sensor 41, the vibration sensor 42, the microphone 43, the lock motor 50, the display 51, the speaker 52, the horn 61, and the Hazard 62.

In the second embodiment, explanations of configuration and operation in common with those of the first embodiment are omitted, and characteristic configuration and operation of the embodiment are explained below. First, the navigation device 35 is a device that sets a proposed driving route of the vehicle to perform a route guidance. The in-vehicle terminal 20 can acquire a location of the vehicle from the navigation device 35, and can acquire a running speed of the vehicle based on change in the location of the vehicle.

The vehicle speed sensor 36 is a sensor that detects the running speed of the vehicle based on, for example, the rotational speed of the wheels, and outputs a detection result to the in-vehicle terminal 20. The starter switch 37 is a switch that is operated with the ignition key, and performs start control of the engine. The in-vehicle terminal 20 acquires a state of the starter switch 37.

Next, processing operation of the in-vehicle terminal 20 according to the second embodiment is explained below. Basic processing operation is the same to the processing flow shown in FIG. 3 in the first embodiment, however, specific processing details of the diagnosis processing and the diagnosis-result notifying processing are different from those according to the first embodiment.

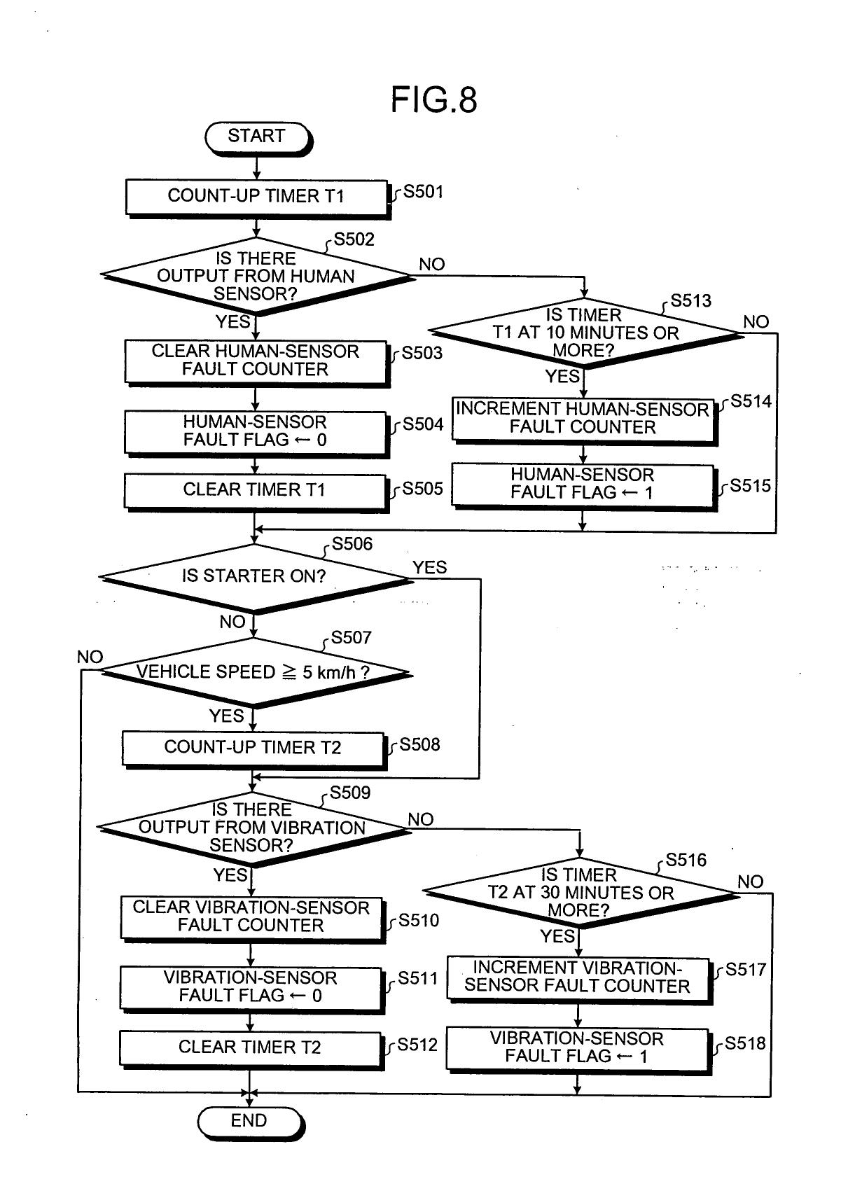

FIG. 8 is a flowchart of a processing operation in diagnosis processing according to the second embodiment. As shown in the figure, the diagnosis processing unit 22a performs count-up of the timer T1 (step S501) at first, and determines whether there is output from the human sensor 41 (step S502). As a result, if there is output from the human sensor 41 (Yes at step S502), the value of a human-sensor fault counter is set to “0” (cleared) (step S503), the value of the human-sensor fault flag is reset to “0” (step S504), and the timer T1 is cleared (step S505).

By contrast, if there is no output from the human sensor 41 (No at step S502), the diagnosis processing unit 22a determines whether the timer T1 is at 10 minutes or more (step S513). If the timer T1 is at 10 minutes or more (Yes at step S513), the value of the human-sensor fault counter is incremented by “1” (step S514), and the value of the human-sensor fault flag is set to “1” (step S515).

After the timer T1 is cleared (step S505), or after the human-sensor fault flag is set (step S515), or when the timer T1 is at less than 10 minutes (No at step S513), the state determining unit 21 determines whether the starter switch 37 is ON (step S506).

If the starter is not ON (No at step S506), in the next, the state determining unit 21 determines whether the vehicle speed of the vehicle is 5 km/h or more (step S507) based on output from the navigation device 35 or the vehicle speed sensor 36. If the vehicle speed of the vehicle is less than 5 km/h (No at step S507), the processing is terminated. By contrast, if the vehicle speed of the vehicle is 5 km/h or more (Yes at step S507), the diagnosis processing unit 22a performs count-up of the timer T2 (step S508).

After the count-up of the timer T2 is finished (step S508), or when the starter switch 37 is ON (Yes at step S506), in the next, the diagnosis processing unit 22a determines whether there is output from the vibration sensor 42 (step S509).

As a result, if there is output from the vibration sensor 42 (Yes at step S509), the value of a vibration-sensor fault counter is turned to “0” (cleared) (step S510), the value of the vibration-sensor fault flag is reset to “0” (step S511), the timer T2 is cleared (step S512), and the processing is terminated.

By contrast, if there is no output from the vibration sensor 42 (No at step S509), the diagnosis processing unit 22a determines whether the timer T2 is at 30 minutes or more (step S516). If the timer T2 is at less than 30 minutes (No at step S516), the processing is terminated. If the timer T2 is at 30 minutes or more (Yes at step S516), the value of the vibration-sensor fault counter is incremented by “1” (step S517), the value of the vibration-sensor fault flag is set to “1” (step S518), and the processing is terminated.

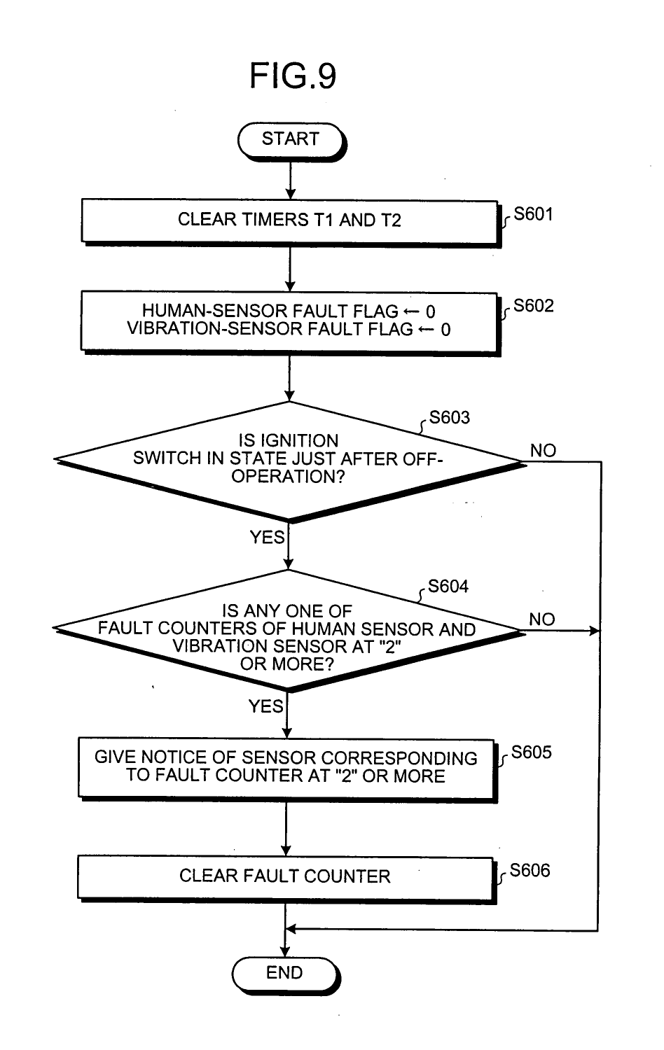

In the next, specific processing details of diagnosis-result notifying processing according to the second embodiment are explained with reference to a flowchart shown in FIG. 9. In the diagnosis-result notifying processing, the diagnosis processing unit 22a clears the values of the timer T1 and the timer T2 (step S601) at first, and resets the values of the human-sensor fault flag and the vibration-sensor fault flag to “0” (step S602).

Subsequently, it is determined whether the ignition switch 33 is in the state just after the OFF-operation (operation of switching from ON to OFF) (step S603). If the ignition switch 33 is not in the state just after the OFF-operation (No at step S603), the processing is terminated.

By contrast, if the ignition switch 33 is in the state just after the OFF-operation (Yes at step S603), the diagnosis processing unit 22a determines that the driving is finished, and then determines whether any one of the fault counters of the human sensor 41 and the vibration sensor 42 has a value “2” or more (step S604).

As a result, if there is no fault count at the value “2” or more (No at step S604), the processing is directly terminated. If there is a fault count at the value “2” or more (Yes at step S604), the corresponding sensor is noticed (step S605), the faulty counter is cleared (step S606), and the processing is terminated.

As described above, the vehicle antitheft system according to the second embodiment performs the diagnosis of the human sensor 41 in the state where the ignition switch 33 is ON, i.e., the state where it is considered that a driver is present inside the vehicle; and performs the diagnosis of the vibration sensor 42 in the state where the starter switch 37 is ON or the vehicle speed is 5 km/h or more, i.e., the state where the vehicle is supposed to vibrate. Moreover, the fault in the sensor is accumulated at each trip, and is notified to the driver at a plurality of trips (two or more trips in the processing flow shown in FIG. 9). For this reason, the fault diagnoses of the sensors can be performed more precisely and more reliably.

The values such as 10 minutes, 30 minutes, 5 km/h or more, and fault count at two or more are mere examples; therefore, can be changed to appropriate values. In addition to the human sensor 41 and the vibration sensor 42 exemplified in the embodiment, any sensor, including the microphone 43, to be used for monitoring in a non-driving state can be diagnosed similarly.

### Third Embodiment

The first and the second embodiments described above have explained the configuration according to which if the ignition switch 33 is ON, it is determined that the vehicle is being driven so that the diagnosis processing is performed, however, determination whether the vehicle is being driven can be performed by any method. In addition, the second embodiment has explained the configuration according to which the sensor fault is accumulated at each time of the trips; however, the sensor fault can be accumulated, for example, by performing the diagnosis processing periodically within the same trip.

A third embodiment then explains below a vehicle antitheft system configured to accumulate the sensor fault by performing the diagnosis processing periodically within the same trip as well as using the vehicle speed for the determination whether the vehicle is being driven.

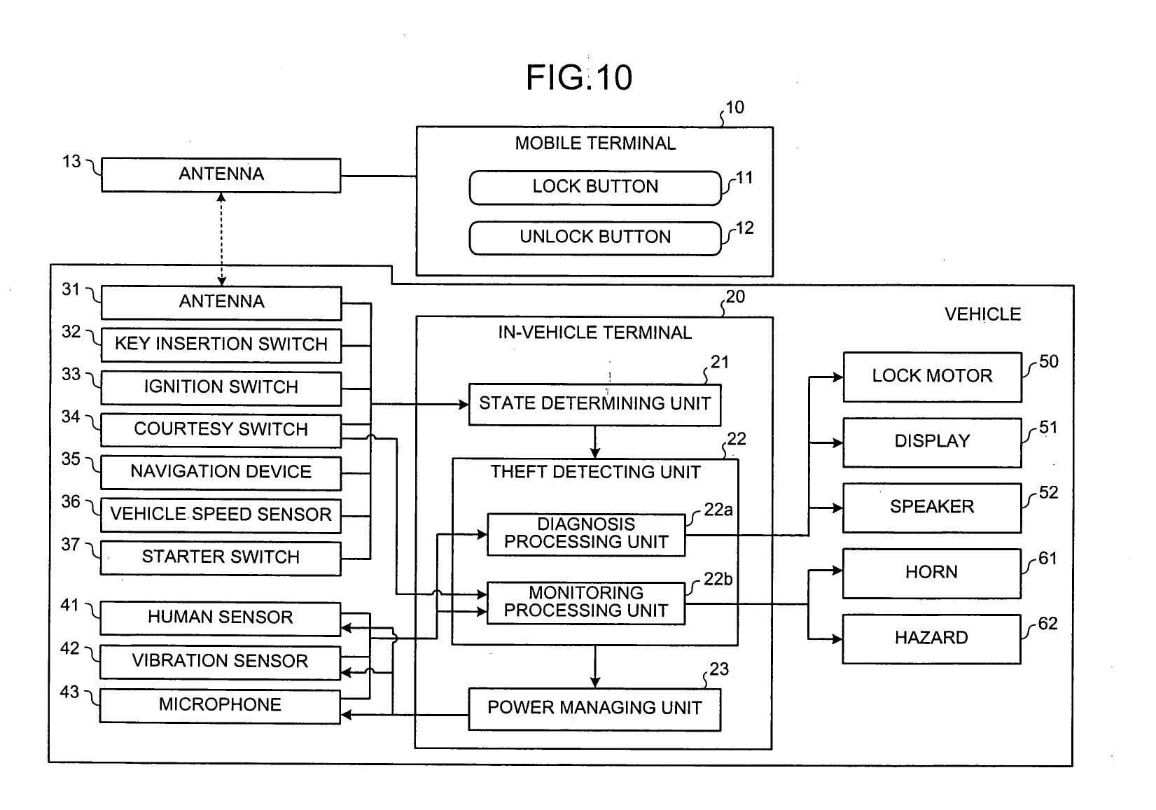

FIG. 10 is a block diagram illustrating a relevant configuration of the vehicle antitheft system according to the third embodiment of the invention. As shown in the figure, the vehicle antitheft system includes the mobile terminal 10, which is a transmitter held by a user, such as a driver, and the in-vehicle terminal 20, which is to be installed on a vehicle. The in-vehicle terminal 20 includes therein a power managing unit 23 in addition to the state determining unit 21 and the theft detecting unit 22. Other configurations and operations are similar to those in the first embodiment or the second embodiment, the same configuration element is assigned with the same reference numeral, and explanation for it is omitted.

In the third embodiment, the state determining unit 21 determines whether the vehicle is being driven based on the running speed of the vehicle acquired from the navigation device 35 or the vehicle speed sensor 36. If it is determined that the vehicle is being driven, the diagnoses of the human sensor 41, the vibration sensor 42, and the microphone 43 are performed, and if the number of times when the sensor fault is detected is a predetermined value or more, notice is given to the driver after the driving is finished.

Furthermore, the power managing unit 23 controls the power supply of the human sensor 41, the vibration sensor 42, and the microphone 43. Accordingly, electricity consumption can be suppressed by carrying out power supply to a sensor subjected to the diagnosis while stopping power supply to a sensor not subjected to the diagnosis.

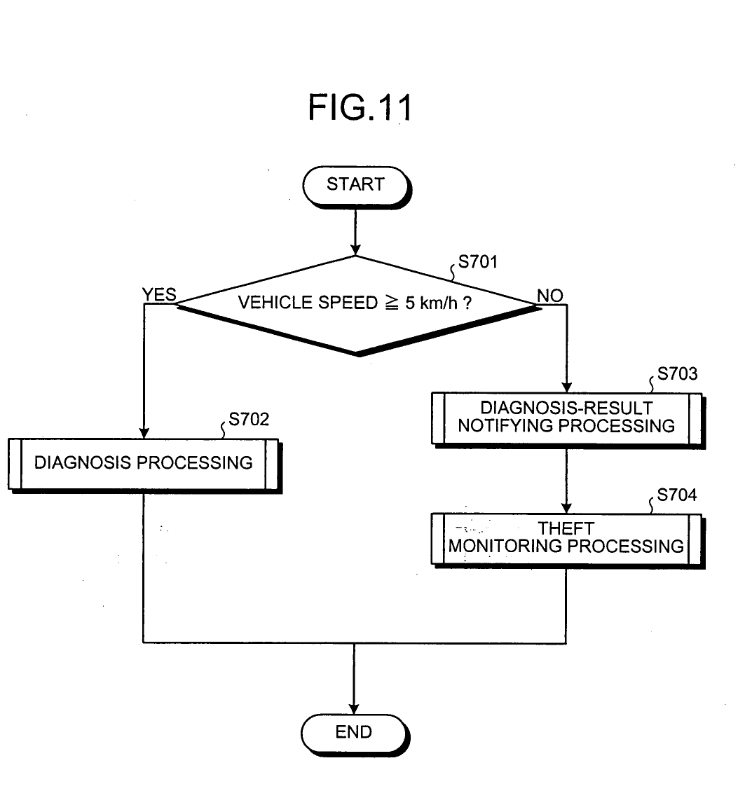

Next, processing operation of the in-vehicle terminal 20 according to the third embodiment is explained below with reference to FIG. 11. Steps in a flowchart shown in the figure are repeated during the power is supplied to the in-vehicle terminal 20.

As shown in the figure, the state determining unit 21 determines at first whether the vehicle speed of the vehicle is 5 km/h or more based on the output from the navigation device 35 or the vehicle speed sensor 36 (step S701). As a result, if the vehicle speed is 5 km/h or more (Yes at step S701), the diagnosis processing unit 22a performs the diagnosis processing (step S702), and then the processing is terminated.

By contrast, if the vehicle speed is less than 5 km/h (No at step S701), the diagnosis processing unit 22a performs the diagnosis-result notifying processing (step S703), and then the monitoring processing unit 22b performs the theft monitoring processing (step S704), and the processing is terminated.

In the following, specific processing details of the diagnosis processing (step S702), and the diagnosis-result notifying processing (step S703) shown in FIG. 11 are explained. Because the theft monitoring processing (step S704) is similar to the theft monitoring processing (step S104) according to the first embodiment, explanation for it is omitted here.

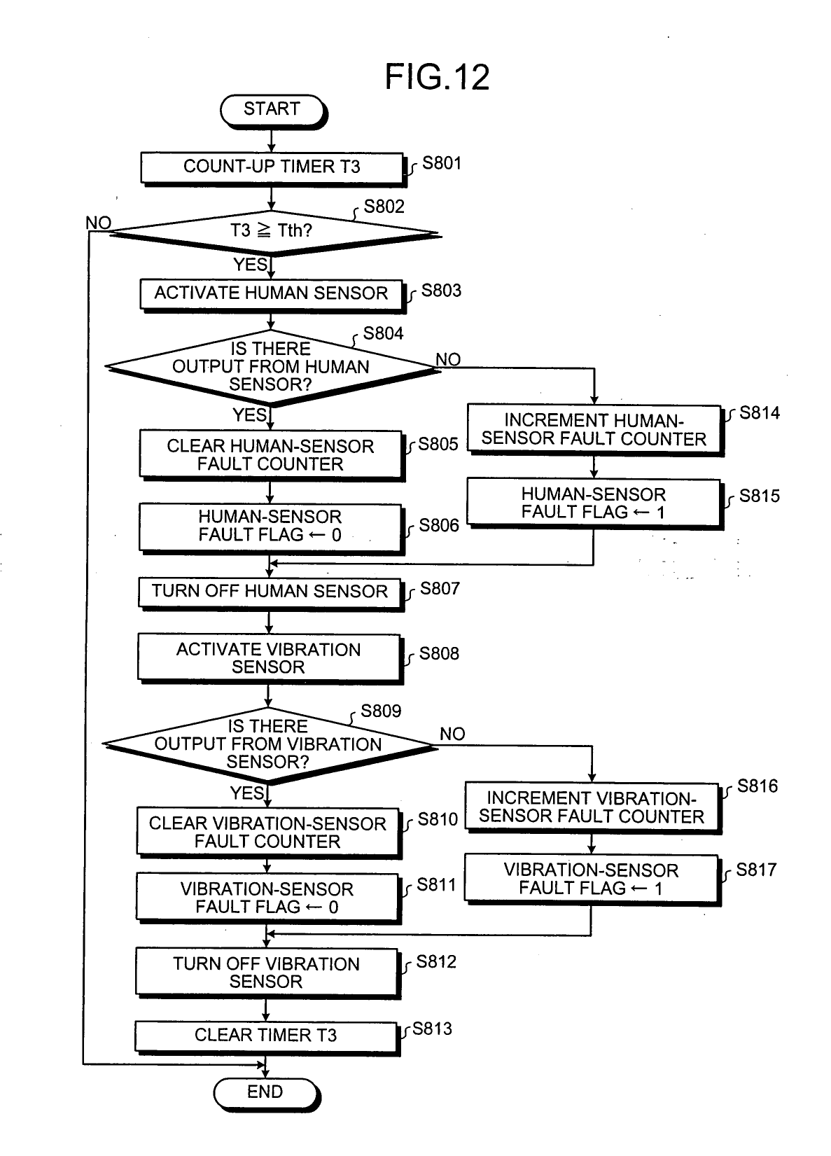

FIG. 12 is a flowchart for explaining specific processing details of the diagnosis processing (step S702). As shown in the figure, the diagnosis processing unit 22a performs count-up of a timer 3 (step S801) at first, and compares a value of the timer 3 with a predetermined threshold Tth (step S802). As a result, if the value of the timer 3 is less than the threshold (No at step S802), the processing is terminated.

By contrast, if the value of the timer 3 is the threshold Tth or more (Yes at step S802), the power managing unit 23 activates the human sensor 41 by supplying the power to the sensor (step S803), and the diagnosis processing unit 22a determines whether there is output from the human sensor 41 (step S804).

As a result, if there is output from the human sensor 41 (Yes at step S804), the value of the human-sensor fault counter is turned to “0” (cleared) (step S805), and the value of the human-sensor fault flag is reset to “0” (step S806).

By contrast, if there is no output from the human sensor 41 (No at step S804), the diagnosis processing unit 22a increments the value of the human-sensor fault counter by “1” (step S814), and sets the value of the vibration-sensor fault flag to “1” (step S815).

After resetting (step S806) or setting (step S815) of the human-sensor fault flag is finished, the power managing unit 23 terminates the power supply to the human sensor 41 to turn off the human sensor 41 (step S807).

The power managing unit 23 then activates the vibration sensor 42 by supplying the power to the sensor (step S808), the diagnosis processing unit 22a determines whether there is output from the vibration sensor 42 (step S809).

As a result, if there is output from the vibration sensor 42 (Yes at step S809), the vibration-sensor fault counter is turned to “0” (cleared) (step S810), and the value of the vibration-sensor fault flag is reset to “0” (step S811).

By contrast, if there is no output from the vibration sensor 42 (No at step S809), the diagnosis processing unit 22a increments the vibration-sensor fault counter by “1” (step S816), and sets the vibration-sensor fault flag to “1” (step S817).

After resetting (step S811) or setting (step S817) of the vibration-sensor fault flag is finished, the power managing unit 23 terminates the power supply to the vibration sensor 42 to turn off the vibration sensor 42 (step S812), the diagnosis processing unit 22a clears the value of the timer T3 (step S813), and the processing is terminated.

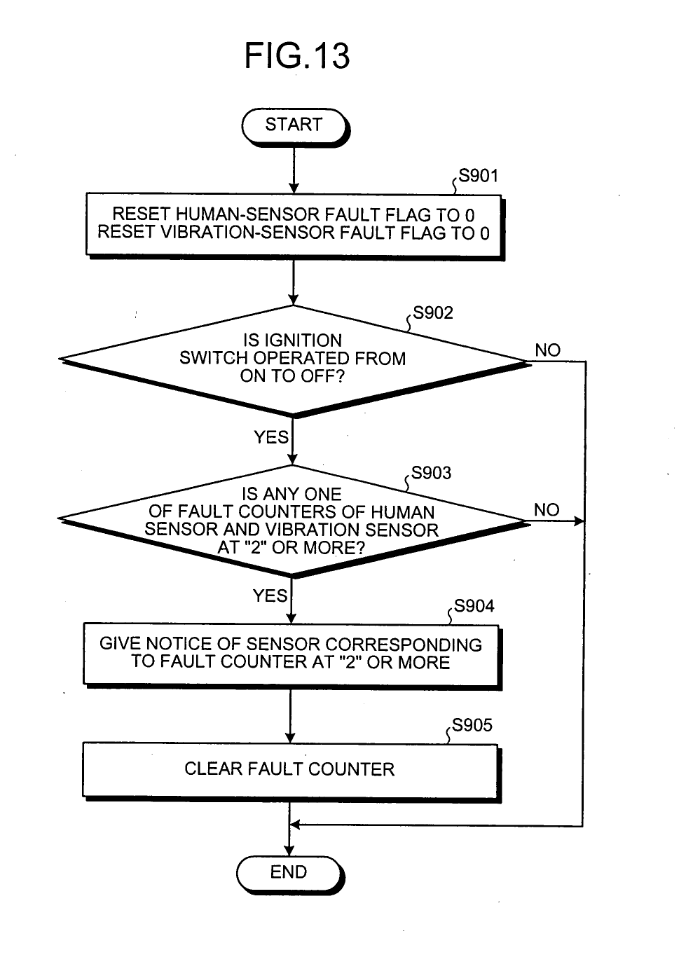

In the next, specific processing details of the diagnosis-result notifying processing (step S703) according to the third embodiment are explained with reference to a flowchart shown in FIG. 13. In the diagnosis-result notifying processing, the diagnosis processing unit 22a resets the human-sensor fault flag and the vibration-sensor fault flag to “0” (step S901).

Subsequently, it is determined whether the ignition switch 33 is in the state just after the OFF-operation (operation of switching from ON to OFF) (step S902). If the ignition switch 33 is not in the state just after the OFF-operation (No at step S902), the processing is terminated.

By contrast, if the ignition switch 33 is in the state just after the OFF-operation (Yes at step S902), the diagnosis processing unit 22a determines that the driving is finished, and then determines whether any one of the fault counters of the human sensor 41 and the vibration sensor 42 has a value “2” or more (step S903).

As a result, if none of the fault counters is at the value “2” or more (No at step S903), the processing is directly terminated. If there is a fault-counter at the value “2” or more (Yes at step S903), the corresponding sensor is noticed (step S904), the fault counter is cleared (step S905), and the processing is terminated.

As described above, the vehicle antitheft system according to the third embodiment performs the diagnosis processing as it is determined that the vehicle is being driven when the running speed of the vehicle is 5 km/h or more.

Moreover, because the diagnosis processing is performed periodically within a trip with a certain interval determined based on the threshold Tth, and the sensor from which the sensor fault is detected twice or more times is notified to the driver, an erroneous diagnosis can be prevented, and notice of a highly reliable diagnosis result can be notified per trip.

Furthermore, electricity consumption can be suppressed by carrying out power supply to a sensor subjected to the diagnosis while stopping power supply to a sensor not subjected to the diagnosis.

The values such as 5 km/h or more, and fault count at two or more are mere examples; therefore, can be changed to appropriate values. In addition to the human sensor 41 and the vibration sensor 42 exemplified in the embodiment, any sensor, including the microphone 43, to be used for monitoring in a non-driving state can be diagnosed similarly.

Furthermore, in the thirst embodiment, the case where it is determined whether the vehicle is being driven based on the vehicle speed is explained, however, the determining method whether the vehicle is being driven can be appropriately changed. For example, a state of the engine, a state of the transmission, and an operation state of the accelerator pedal can be used for determination whether the vehicle is being driven.

In the first to third embodiments, the cases where the present invention is applied to the antitheft system are explained, however, the present invention can be widely applied to systems for monitoring the vehicle and the surroundings in a non-driving state, such as a remote starting system of the engine, and a keyless entry system.

### INDUSTRIAL APPLICABILITY

As described above, the vehicle control apparatus and the vehicle control method according to the present invention is effective for diagnosis of an in-vehicle sensor, and particularly suitable for automatic diagnosis of a sensor to be used in a non-driving state.

1-15. (canceled)

16. A vehicle control apparatus that performs a monitoring control of a vehicle in a non-driving state based on a sensor that collects information for the monitoring control, the vehicle control apparatus comprising:
a driving-state determining unit that determines a driving state of the vehicle; and
a fault diagnosis unit that performs a fault diagnosis of the sensor upon the driving-state determining unit determining that the vehicle is in a driving state.

17. The vehicle control apparatus according to claim 16, wherein if the sensor is normal, an output from the sensor is changed while the vehicle is in the driving state.

18. The vehicle control apparatus according to claim 16, wherein
the sensor is a human detecting sensor that detects a human body with at least one of ultrasonic wave and radio wave, and
the monitoring control is to monitor an intrusion of a person into the vehicle based on an output from the human detecting sensor.

19. The vehicle control apparatus according to claim 16, wherein
the sensor is a vibration detecting sensor that detects a vibration of the vehicle, and
the monitoring control is to monitor a vehicle theft based on an output from the vibration detecting sensor.

20. The vehicle control apparatus according to claim 16, wherein
the sensor is an impact-sound sensor that detects an impact sound, and
the monitoring control is to monitor an occurrence of an impact on at least one of a body and a glass of the vehicle.

21. the vehicle control apparatus according to claim 16, wherein when the vehicle is in the driving state, and when the sensor outputs what is supposed to be output along with a driving operation, the fault diagnosis unit diagnoses that the sensor is normal.

22. The vehicle control apparatus according to claim 16, wherein when the vehicle is in the driving state, and when the sensor dose not output what is supposed to be output along with a driving operation, the fault diagnosis unit diagnoses that the sensor has a fault.

23. The vehicle control apparatus according to claim 22, wherein when the vehicle is in the driving state, and if the sensor dose not output what is supposed to be output along with the driving operation for a predetermined time, the fault diagnosis unit diagnoses that the sensor has a fault.

24. The vehicle control apparatus according to claim 22, wherein the fault diagnosis unit performs the fault diagnosis during one trip from a beginning of driving to an end of driving, and if the fault diagnosis unit diagnoses that the sensor is faulty across a plurality of trips, the fault diagnosis unit diagnoses that the sensor has a fault.

25. The vehicle control apparatus according to claim 16, wherein the fault diagnosis unit makes a notification of a result of the fault diagnosis after a vehicle driving is ended.

26. The vehicle control apparatus according to claim 16, wherein when an ignition switch is turned ON, the driving-state determining unit determines that the vehicle is in the driving state.

27. The vehicle control apparatus according to claim 16, wherein when an engine is in operation, the driving-state determining unit determines that the vehicle is in the driving state.

28. The vehicle control apparatus according to claim 16, wherein when the vehicle is running at a predetermined speed or faster, the driving-state determining unit determines that the vehicle is in the driving state.

29. The vehicle control apparatus according to claim 16, further comprising a power managing unit that manages a power supply to the sensor, wherein
the power managing unit selectively performs the power supply to the sensor when the monitoring control is performed using the sensor and when the fault diagnosis of the sensor is performed.

30. A vehicle control method of performing a monitoring control of a vehicle in a non-driving state based on a sensor that collects information for the monitoring control, the vehicle control method comprising:
determining a driving state of the vehicle; and
performing a fault diagnosis of the sensor when it is determined that the vehicle is in a driving state.
